(19) United States
(12) Patent Application Publication
(10) Pub. No.: US 2012/0097490 A1
(43) Pub. Date: Apr. 26, 2012

(54) Retaining Bolt

(75) Inventors: Herbert Vollert, Vaihingen/Enz (DE); Anton Dukart, Gerlingen (DE); Bertram Foitzik, Ilsfeld (DE); Willi Nagel, Remseck/Hochdorf (DE); Bernd Goetzelmann, Rutesheim (DE); Joern Tilsch, Stuttgart (DE)

(73) Assignee: Robert Bosch GmbH, Stuggart (DE)

(21) Appl. No.: 13/377,507

(22) PCT Filed: Jul. 27, 2009
(86) PCT No.: PCT/EP2009/059630

§ 371 Date: Dec. 9, 2011

(30) Foreign Application Priority Data
Sep. 23, 2008 (DE) 10 2008 042 298.3
Jul. 15, 2009 (DE) 10 2009 027 737.4

(51) Int. Cl. F16D 65/02; B61H 5/00; F16B 31/02; F16D 55/22

(52) U.S. Cl. 188/73.31; 73/761

(57) ABSTRACT

A retaining bolt for attaching a brake caliper to a support is attached. The retaining bolt is hollow and includes a retaining element which is fixed on one side in a cavity of the retaining bolt, supporting a permanent magnet on a free end. When the retaining bolt is moved due to an external load, the permanent magnet moves in the cavity of the retaining bolt and the modification of the magnetic field thus produced can be measured by a magnetic sensor. The retaining bolt allows the braking power of the disk brake to be measured.

### PRIOR ART

The invention relates to a retaining bolt for fastening one component to another component, having the features of the preamble of claim 1. In particular, the retaining bolt is provided for fastening a brake to a carrier, wherein the carrier may be, for example, a motor vehicle wheel carrier, on which a wheel hub is rotatably mounted, or a truck of a rail vehicle.

International patent application WO 92/00464 discloses a disk brake, the brake caliper of which is mounted in a brake holder in a floating manner, i.e. so as to be displaceable transversely with respect to a brake disk. The floating mounting is brought about by studs which are screwed into the brake holder and which have a thread-free section which protrudes out of the brake holder and the protruding end of which is rounded spherically. The studs are arranged on both sides of a brake disk in the direction of a secant. The rounded end engages in grooves which are formed transversely with respect to the brake disk at both ends of the brake caliper. The studs are partially tubular and have a sleeve which is subjected to a compressive stress and on the outside of which strain gauges are arranged. During braking, the brake caliper is supported on two of the studs which are elastically deformed as a result, i.e. are compressed in the axial direction thereof. The deformation can be measured with the strain gauge, and the supporting force, with which the brake caliper is supported on the brake holder, can be measured from the deformation, the supporting force being identical in magnitude to the braking force, which can thereby be measured.

A retaining bolt within the context of the invention means an elongate element with a preferably round cross section. The retaining bolt is preferably longer than the diameter thereof, but this is not compulsory. The retaining bolt may have a cross section which is constant over the length thereof, for example may be cylindrical, or the cross section changes and the retaining bolt may be, for example, conical. For example, oval or elliptical cross sections which deviate from a circular shape are possible, as are noncircular cross sections, for example polygonal or multi-toothed profiles, said profiles being assigned per se to the circular cross sections. The retaining bolt may be thread-free or may have a thread over the entire or part of the length thereof. The retaining bolt may also have a head or one or more flanges.

Furthermore, the invention relates to an arrangement for fastening a brake with a retaining bolt of this type.

### DISCLOSURE OF THE INVENTION

The retaining bolt according to the invention having the features of claim 1 has a cavity which extends over part or the entire length of the retaining bolt. For example, the retaining bolt is tubular in the region of the cavity. A holder which is connected to the holder at one or more fastening points is arranged in the cavity. For example, the holder is rod-shaped, i.e. is elongate. The holder may be fastened, for example, at one end and the other end thereof may be free. Fastening to both ends of the holder is also possible. The holder is arranged and fastened in the retaining bolt in such a manner that said holder moves with respect to the retaining bolt at a distance from the fastening point or between the fastening points if the retaining bolt is (elastically) deformed by a mechanical load. In particular during bending of the retaining bolt, the holder changes its position in the cavity of the retaining bolt. The retaining bolt has a device for measuring the position or change in position or movement of the holder with respect to the retaining bolt upon deformation of the retaining bolt. A conclusion can be drawn regarding the load on the retaining bolt from the measurement of the movement of the holder with respect to the retaining bolt. When the retaining bolt is used to fasten a brake, a conclusion can be drawn regarding the force with which the brake has to be held during braking, and therefore regarding the braking force. This is the actual purpose of the invention. However, the invention is not restricted to said use, and it is possible, with the retaining bolt according to the invention, in general to determine forces which act on components which are fastened with one or more retaining bolts, wherein there may be other fastening elements in addition to the retaining bolts according to the invention. One advantage of the invention is the protected arrangement of the measuring device in the cavity of the holder.

The dependent claims relate to advantageous refinements and developments of the invention specified in claim 1.

Claim 6 makes provision for the generation and measurement of an electric and/or magnetic field for measuring the movement of the holder with respect to the retaining bolt upon deformation of the retaining bolt. For example, the holder bears a permanent magnet, the magnetic field of which is measured with a magnet sensor which is arranged in the cavity of the retaining bolt. It is also conceivable to measure the change in an electric, magnetic or electromagnetic, constant or alternating field in the cavity of the retaining bolt by movement of the holder in the cavity upon deformation of the retaining bolt, i.e. more or less a “detuning” of the field.

### BRIEF DESCRIPTION OF THE DRAWING

The invention is explained in more detail below with reference to an exemplary embodiment which is illustrated in the drawing, in which:

FIG. 1 shows a simplified schematic illustration of a train brake which is fastened with a retaining bolt according to the invention; and

FIG. 2 shows the retaining bolt from FIG. 1 elastically deformed by a load during braking.

### DESCRIPTION OF THE EMBODIMENT

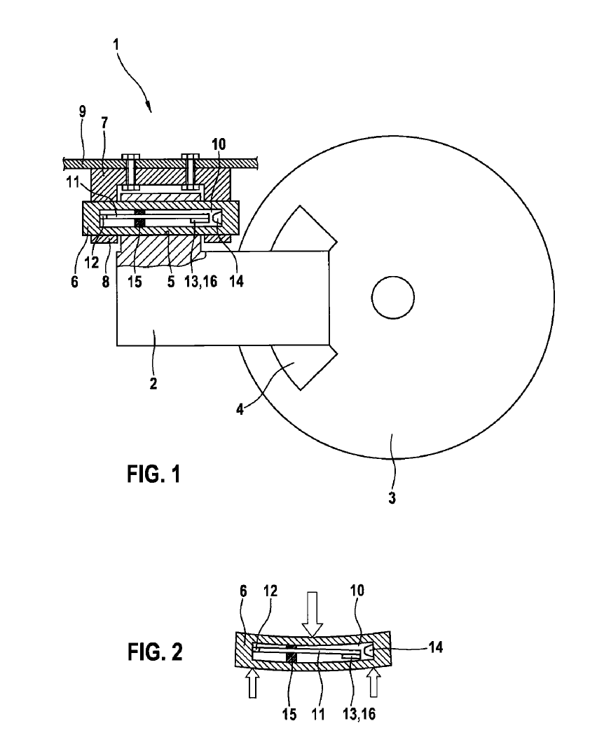

FIG. 1 shows a train disk brake 1 with a brake caliper 2, in which friction brake linings 4 lie on both sides of a brake disk 3. In order to actuate a brake, one of the two friction brake linings 4 can be pressed hydraulically with a brake piston (not visible in the drawing) against the brake disk 3. The brake piston is displaceable in a cylinder bore in the brake caliper 2 transversely with respect to the brake disk 3. The brake caliper 2 is mounted in a floating manner, i.e. is movable transversely with respect to the brake disk 3, such that, by pressing of the one friction brake lining 4 against the brake disk 3, the brake caliper 2 is moved transversely with respect to the brake disk 3 and presses the other friction brake lining against the other side of the brake disk 3. The brake disk 3 is braked as a result.

The brake caliper 2 has a cylindrical bearing hole 5 through which a retaining bolt 6 according to the invention, on which the brake caliper 2 is pivotably mounted, is inserted. The bearing hole 5 is relatively long, approximately twice as long as the diameter thereof, in order to support the brake caliper 2 radially with respect to the retaining bolt 6 against tilting about an imaginary axis. The retaining bolt 6 is arranged in a brake disk plane. By means of the pivotability about the retaining bolt 6, the brake caliper 2 is movable transversely with respect to the brake disk 3, i.e. is mounted in a floating manner.

The retaining bolt 6 is fastened to a brake anchor plate 7 which has a C-shaped profile and the two limbs 8 of which have passage holes in which the retaining bolt 6 is accommodated with a press fit. The brake anchor plate 7 is fastened, for example screwed, to a truck 9 of a rail vehicle (otherwise not illustrated).

The retaining bolt 6 is tubular, has a cavity 10 and is closed at both ends. A rod- or strip-shaped holder 11 is arranged in the cavity 10 in a manner running in the longitudinal direction of the retaining bolt 6. One end of the holder 11 is fastened at one end of the cavity in the retaining bolt 6, said end forming a fastening point 12 of the holder 11. The other end of the holder 11 is free and bears a permanent magnet 13. At an end of the cavity 10 in the vicinity of the free end of the holder 11, a magnet sensor 14, with which a magnetic field of the permanent magnet 13 can be measured, is arranged in the retaining bolt 6. A support 15 which is composed, for example, of plastic is arranged in the cavity 10. A circumference of the support 15 corresponds to a cross section of the cavity of the retaining bolt 6. The support 15 has a passage hole which is congruent with respect to the one cross section of the holder 11 and the holder 11 reaches through said passage hole. The support 15 is displaceable in the longitudinal direction of the retaining bolt 6 and supports the holder 11 between the fastening point 12 and the free end. By means of the displaceability of the support 15, a free length of the holder 11 can be set and, as a result, can be matched to the loads on the retaining bolt 6. The free end of the holder 11, which end bears the permanent magnet 13, forms a measuring point 16.

Upon actuation of a brake, the retaining bolt 6 is loaded in the central region thereof transversely with respect to the longitudinal direction thereof by the brake caliper 2 and is supported against the load by the limbs 8 of the brake anchor plate 7. As a result, the retaining bolt 6 is bent elastically, as illustrated in exaggerated form in FIG. 2. The holder 11 is not loaded in the cavity 10 of the retaining bolt 6 between the support 15 and the free end of said holder, i.e. is not deformed in this region. As a result, the free end of the holder 11, which end bears the permanent magnet 13 and forms the measuring point 16, moves in the cavity 10 transversely with respect to the retaining bolt 6. A magnetic field of the permanent magnet 16 changes, or at least changes its position in the cavity 10 of the retaining bolt 6. The change of the magnetic field, and therefore the movement of the holder 11 in the retaining bolt 6 due to the bending of the retaining bolt 6 upon loading, can be measured with the magnet sensor 14. Therefore, ultimately, the load on the retaining bolt 6 can be measured, the load corresponding to a braking force which a disk brake 1 exerts on the brake disk 3. Measurement sensitivity can be matched to the load on the retaining bolt 6 by displacement of the support 15. Instead of a magnetic field, the measurement of an electric or electromagnetic field is also conceivable. For example, a “detuning” of an alternating electric field can be measured by the movement of the holder 13 in the cavity 10 upon bending of the retaining bolt 6.

The holder 11 has at least approximately the same coefficient of thermal expansion as the retaining bolt in order to avoid a change in the position of the permanent magnet 13 with respect to the magnet sensor 14 due to a change in temperature.

The invention also relates to the arrangement of the disk brake 1, i.e. to the fastening of the disk brake 1 or the brake caliper 2 thereof with the retaining bolt 6 according to the invention. Other vehicle brakes, for example motor vehicle brakes, and other brakes, for example drum brakes, can also be fastened with the retaining bolt 6 in order to be able to measure and determine a braking force (not illustrated). The retaining bolt 6 also permits the measurement of other loads and forces, and the use thereof is not restricted to brakes.

The permanent magnet 16 and the magnet sensor 14 form a measuring device 14, 16 for measuring a movement of the holder 11 with respect to the retaining bolt 6 upon bending of the retaining bolt 6.

1. A retaining bolt assembly for fastening a component to another component, comprising:
a retaining bolt defining a cavity;
a holder connected to the retaining bolt at a fastening point and arranged in the cavity; and
a measuring device configured to measure a movement of the holder with respect to the retaining bolt at a measuring point at a distance from the fastening point.

2. The retaining bolt as claimed in claim 1, wherein the retaining bolt is configured to be tubular in the region of the cavity.

3. The retaining bolt as claimed in claim 1, wherein the holder is rod-shaped.

4. The retaining bolt as claimed in claim 1, wherein the fastening point is located at one end of the holder and another end of the holder is free.

5. The retaining bolt as claimed in claim 1, wherein a free length of the holder can be set.

6. The retaining bolt as claimed in claim 1, wherein the measuring device is configured to generate and measure an electric and/or magnetic field.

7. The retaining bolt as claimed in claim 1, wherein the holder has the same coefficient of thermal expansion as the retaining bolt.

8. An arrangement, comprising:
a brake;
an anchor plate; and
a retaining bolt assembly configured to fasten the brake to the anchor plate, the retaining bolt assembly including (i) a retaining bolt defining a cavity, (ii) a holder connected to the retaining bolt at a fastening point and arranged in the cavity; and (iii) a measuring device configured to measure a movement of the holder with respect to the retaining bolt at a measuring point at a distance from the fastening point.

9. The arrangement as claimed in claim 8, wherein:
the brake is a disk brake having a brake caliper, and
the brake caliper is fastened to the anchor plate with the retaining bolt.
